(19) United States
(12) Patent Application Publication
(10) Pub. No.: US 2026/0323688 A1
(43) Pub. Date: Oct. 15, 2026

(54) METHOD AND APPARATUS FOR SHARING CHANNEL OCCUPANCY TIME BETWEEN TERMINALS IN SIDELINK COMMUNICATION

(71) Applicant: Intellectual Discovery Co., Ltd., Seoul (KR)

(72) Inventor: Hyuk Min SON, Seoul (KR)

(21) Appl. No.: 19/466,989

(22) Filed: Feb. 2, 2026

Related U.S. Application Data
(63) Continuation of application No. PCT/KR2024/010813, filed on Jul. 25, 2024.

(30) Foreign Application Priority Data
Aug. 4, 2023 (KR) 10-2023-0102106
Jul. 23, 2024 (KR) 10-2024-0096981

(51) Int. Cl. H04W 74/0808; H04W 72/25

(52) U.S. Cl. CPC H04W 74/0808; H04W 72/25

(57) ABSTRACT

Sidelink communication methods and apparatus are described. According to one embodiment, the method comprises receiving a first physical sidelink control channel (PSCCH) and receiving a first physical sidelink shared channel (PSSCH) after the receiving the first PSCCH, wherein first sidelink control information (SCI) received via the first PSCCH includes first channel occupancy time (COT) sharing information.

### CROSS-REFERENCE TO RELATED APPLICATIONS

This application is a continuation of PCT Application No. PCT/KR2024/010813, filed on Jul. 25, 2024, which claims priority from Korean Patent Application No. 10-2023-0102106, filed on Aug. 4, 2023, and Korean Patent Application No. 10-2024-0096981, filed on Jul. 23, 2024, which are also incorporated herein by reference in their entirety.

### BACKGROUND OF THE DISCLOSURE

### Technical Field

The present disclosure relates to 3GPP 5G sidelink communication.

### Background Art

As an increasing number of communication devices demand greater communication traffic over time, a next-generation 5G system, which is an enhanced wireless broadband communication system compared to the conventional LTE system, is required. In this next-generation 5G system, also referred to as NewRAT, communication scenarios are classified into Enhanced Mobile Broadband (eMBB), Ultra-Reliability and Low-Latency Communication (URLLC), Massive Machine-Type Communications (mMTC), and so on.

Here, eMBB is a next-generation mobile communication scenario that has characteristics such as High Spectrum Efficiency, High User Experienced Data Rate, and High Peak Data Rate. URLLC is a next-generation mobile communication scenario characterized by features such as Ultra Reliability, Ultra Low Latency, and Ultra High Availability (e.g., V2X, Emergency Service, Remote Control). mMTC is a next-generation mobile communication scenario characterized by features such as Low Cost, Low Energy, Short Packet, and Massive Connectivity (e.g., IoT).

### SUMMARY OF THE DISCLOSURE

The present disclosure is to provide a method and apparatus for sharing a channel occupancy time between terminals in sidelink communication.

An embodiment of the present specification provides a method in which, in sidelink (SL) communication, a terminal receives a first physical sidelink control channel (PSCCH). After receiving the first PSCCH, the terminal receives a first physical sidelink shared channel (PSSCH), wherein first sidelink control information (SCI) received via the first PSCCH includes first channel occupancy time (COT) sharing information.

Further, an embodiment of the present specification provides a receiving terminal for sidelink (SL) communication, comprising a control unit, and a memory unit storing instructions and being operably and electrically connectable to the control unit, wherein operations performed based on the instructions being executed by the control unit comprise: receiving a first physical sidelink control channel (PSCCH), and after receiving the first PSCCH, receiving a first physical sidelink shared channel (PSSCH), wherein first sidelink control information (SCI) received via the first PSCCH includes first channel occupancy time (COT) sharing information.

Meanwhile, the first SCI may be a 1st stage SCI, and the first COT sharing information may be 1-bit information. In addition, remaining COT duration information may be obtained through the first COT sharing information.

After receiving the 1st stage SCI, a 2nd stage SCI may be received via the first PSSCH, and the 2nd stage SCI may include second COT sharing information.

A second PSCCH and a second PSSCH may be transmitted to another terminal, wherein second SCI transmitted via the second PSCCH may include third COT sharing information.

According to the disclosure of the present specification, a channel occupancy time (COT) sharing operation between terminals for sidelink communication can be efficiently performed.

### BRIEF DESCRIPTION OF THE DRAWINGS

FIG. 1 is a diagram illustrating a New Radio (NR) wireless communication system.

FIG. 2 illustrates a structure of a radio frame used in the NR.

FIG. 3 illustrates a slot structure of an NR frame.

FIG. 4 illustrates an example of a Next Generation Radio Access Network (NG-RAN) architecture that supports a PC5 interface.

FIGS. 5A to 5B illustrate procedures for performing sidelink communication according to a sidelink resource allocation mode.

FIG. 6 illustrates an operation method of a terminal according to an embodiment of the present specification.

FIG. 7 illustrates a wireless communication apparatus according to an embodiment of the present specification.

### DETAILED DESCRIPTION OF THE DISCLOSURE

Although embodiments are described herein using an LTE system, an LTE-A system, and an NR system, these embodiments may be applied to any communication system corresponding to the above definitions.

Furthermore, in the present specification, the term ‘base station’ may be used as a comprehensive term that includes a remote radio head (RRH), an eNB, a transmission point (TP), a reception point (RP), a relay, and the like.

3GPP-based communication standards define downlink physical channels corresponding to resource elements that carry information originating from a higher layer, and downlink physical signals corresponding to resource elements that are used by the physical layer but do not carry information originating from a higher layer. For example, the physical downlink shared channel (PDSCH), physical broadcast channel (PBCH), physical multicast channel (PMCH), physical control format indicator channel (PCFICH), physical downlink control channel (PDCCH), and physical hybrid ARQ indicator channel (PHICH) are defined as downlink physical channels, and a reference signal and a synchronization signal are defined as downlink physical signals. A reference signal (RS), also referred to as a pilot, means a predefined special waveform signal known to both a gNB and a UE. For example, cell-specific RS, UE-specific RS (UE-RS), positioning RS (PRS), and channel state information RS (CSI-RS) are defined as downlink reference signals. 3GPP LTE/LTE-A standards define uplink physical channels corresponding to resource elements that carry information originating from a higher layer, and uplink physical signals corresponding to resource elements that are used by the physical layer but do not carry information originating from a higher layer. For example, the physical uplink shared channel (PUSCH), physical uplink control channel (PUCCH), and physical random access channel (PRACH) are defined as uplink physical channels, and a demodulation reference signal (DMRS) for uplink control/data signals and a sounding reference signal (SRS) used for uplink channel measurement are defined.

In this specification, Physical Downlink Control Channel (PDCCH)/Physical Control Format Indicator Channel (PCFICH)/Physical Hybrid automatic retransmit request Indicator Channel (PHICH)/Physical Downlink Shared Channel (PDSCH) respectively mean a set of time-frequency resources or a set of resource elements carrying Downlink Control Information (DCI)/Control Format Indicator (CFI)/downlink ACKnowledgement/Negative ACK (ACK/NACK)/downlink data. Furthermore, Physical Uplink Control Channel (PUCCH)/Physical Uplink Shared Channel (PUSCH)/Physical Random Access Channel (PRACH) respectively mean a set of time-frequency resources or a set of resource elements carrying Uplink Control Information (UCI)/uplink data/random access signals.

Meanwhile, an NR frequency band may be defined with two types of frequency ranges (FR1 and FR2). The numerical values of the frequency ranges may be changed. For example, the two types of frequency ranges (FR1 and FR2) may be as shown in Table 1 below. For convenience of description, among the frequency ranges used in the NR system, FR1 may mean a “sub 6 GHz range”, and FR2 may mean an “above 6 GHz range” and may be called a millimeter wave (mmW).

TABLE 1

| Frequency Range | Corresponding | Subcarrier |
|---|---|---|
| designation | frequency range | Spacing |
| FR1 | 410 MHz-7125 MHz | 15, 30, 60 kHz |
| FR2 | 24250 MHz-52600 MHz | 60, 120, 240 kHz |

The numerical values of the frequency range of the NR system may be changed. For example, FR1 may include a band from 410 MHz to 7125 MHz as in Table 1. That is, FR1 may include a frequency band of 6 GHZ (or 5850, 5900, 5925 MHz, etc.) or higher. For example, the frequency band of 6 GHz (or 5850, 5900, 5925 MHz, etc.) or higher included in FR1 may include an unlicensed band. The unlicensed band may be used for various purposes, for example, for communication for vehicles (e.g., autonomous driving).

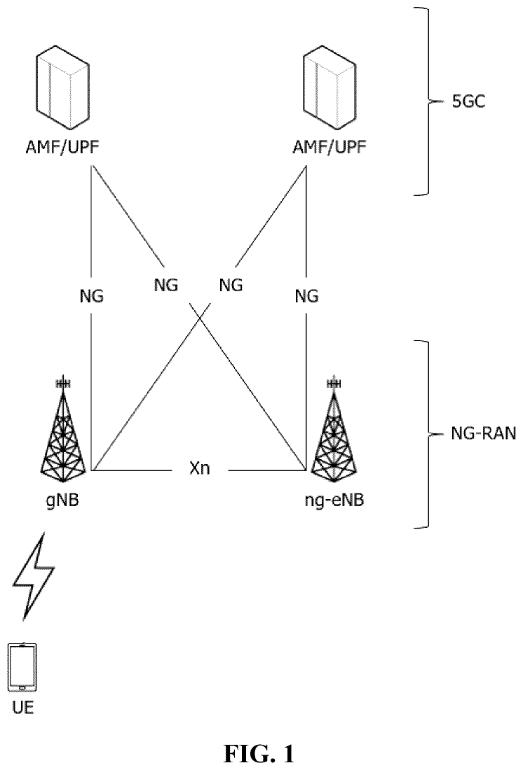

FIG. 1 is a diagram illustrating an NR wireless communication system.

Referring to FIG. 1, the NR wireless communication system may be classified into a 5G core network (5GC) and a next generation-radio access network (NG-RAN), and the NG-RAN may include base stations (gNB and/or ng-eNB) that provide user plane and control plane protocol termination to a user equipment (UE). A gNB (next generation-Node B) provides NR user plane and control plane protocol termination to the UE, and an ng-eNB (next generation-evolved Node B) provides evolved-universal terrestrial radio access (E-UTRA) user plane and control plane protocol termination to the UE. The user equipment (UE) may be fixed or have mobility, and may be called by other terms such as mobile station (MS), user terminal (UT), subscriber station (SS), mobile terminal (MT), or wireless device. The base station (gNB and/or ng-eNB) may be a fixed station that communicates with the UE, and may be called by other terms such as base transceiver system (BTS), access point, etc.

The base stations (gNB and/or ng-eNB) may be connected to each other via an Xn interface, and may be connected to a 5G core network (5GC) via an NG interface. Specifically, the base stations (gNB and/or ng-eNB) may be connected to an access and mobility management function (AMF) via an NG-C interface, and may be connected to a user plane function (UPF) via an NG-U interface.

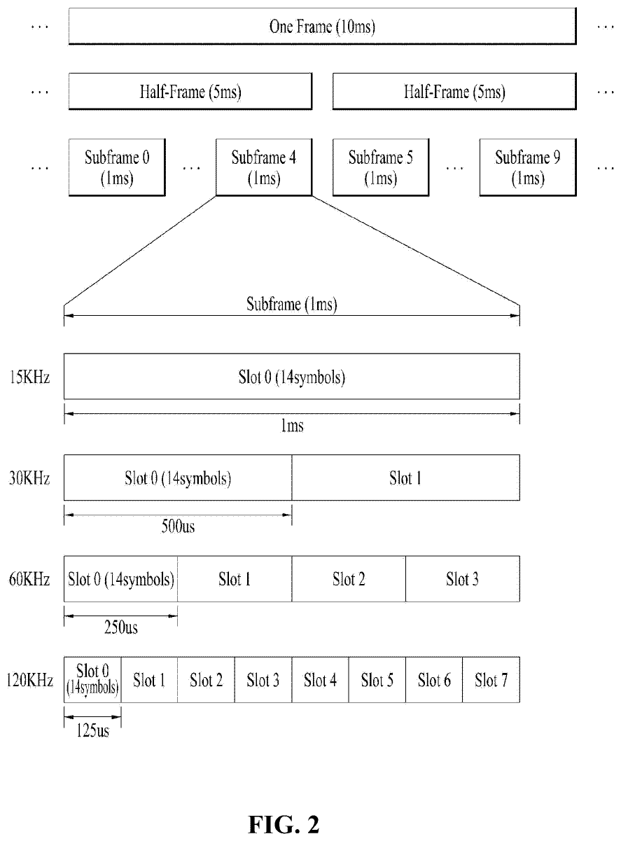

FIG. 2 illustrates a structure of a radio frame used in NR.

In NR, uplink and downlink transmissions are composed of frames. A radio frame has a length of 10 ms and is defined by two 5 ms Half-Frames (HFs). A half-frame is defined by five 1 ms subframes (SFs). A subframe is divided into one or more slots, and the number of slots within a subframe depends on the subcarrier spacing (SCS). Each slot includes 12 or 14 OFDM (A) symbols depending on the cyclic prefix (CP). In the case of normal CP, each slot includes 14 symbols. In the case of extended CP, each slot includes 12 symbols. Here, a symbol may include an OFDM symbol (or CP-OFDM symbol) or an SC-FDMA symbol (or DFT-s-OFDM symbol).

Table 2 illustrates that when normal CP is used, the number of symbols per slot, the number of slots per frame, and the number of slots per subframe vary depending on the SCS.

TABLE 2

| SCS(15*2^{u}) | N^{slot}_{symb} | N^{frame, u}ₛₗₒₜ | N^{subframe, u}ₛₗₒₜ |
|---|---|---|---|
| 15 KHz(u = 0) | 14 | 10 | 1 |
| 30 KHz(u = 1) | 14 | 20 | 2 |
| 60 KHz(u = 2) | 14 | 40 | 4 |
| 120 KHz(u = 3) | 14 | 80 | 8 |
| 240 KHz(u = 4) | 14 | 160 | 16 |

N^{slot}_{symb}: number of symbols in a slot
N^{frame, u}ₛₗₒₜ: number of slots in a frame
N^{subframe, u}ₛₗₒₜ: number of slots in a subframe

Table 3 illustrates that when extended CP is used, the number of symbols per slot, the number of slots per frame, and the number of slots per subframe vary depending on the SCS.

TABLE 3

| SCS (15*2^{u}) | N^{slot}_{symb} | N^{frame, μ}ₛₗₒₜ | N^{subframe, μ}ₛₗₒₜ |
|---|---|---|---|
| 60 KHz (u = 2) | 12 | 40 | 4 |

In an NR system, OFDM (A) numerology (e.g., SCS, CP length, etc.) may be set differently among a plurality of cells that are aggregated for a single UE. Accordingly, the (absolute time) duration of a time resource (e.g., SF, slot, or TTI) composed of the same number of symbols (collectively referred to as a Time Unit (TU) for convenience) may be set differently among the aggregated cells.

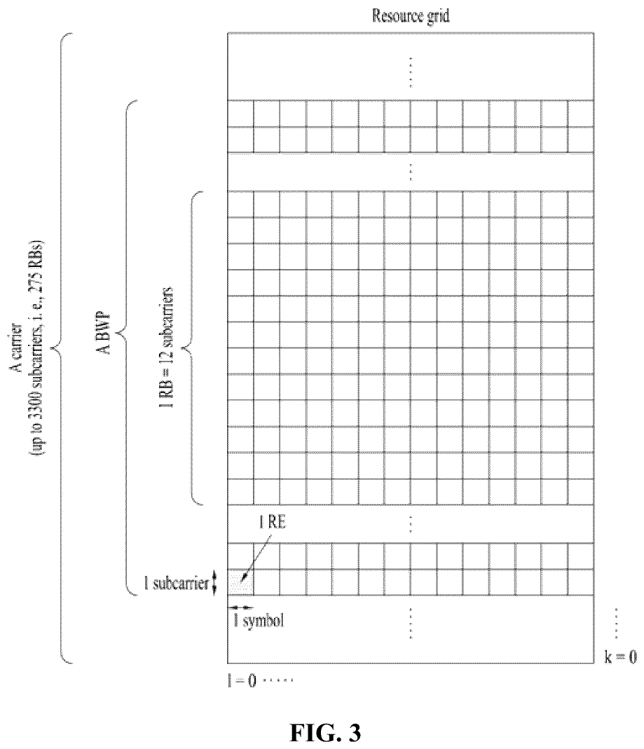

FIG. 3 illustrates a slot structure of an NR frame.

A slot includes a plurality of symbols in the time domain. For example, in the case of normal CP, one slot includes 14 symbols, but in the case of extended CP, one slot includes 12 symbols. A carrier includes a plurality of subcarriers in the frequency domain. A resource block (RB) is defined by a plurality of (e.g., 12) consecutive subcarriers in the frequency domain. A bandwidth part (BWP) is defined by a plurality of consecutive (P) RBs in the frequency domain, and may correspond to one numerology (e.g., SCS, CP length, etc.). A carrier may include up to N (e.g., 4) BWPs. Data communication is performed through an activated BWP, and only one BWP may be activated for one UE. Each element in a resource grid is referred to as a Resource Element (RE), and one complex symbol may be mapped to it.

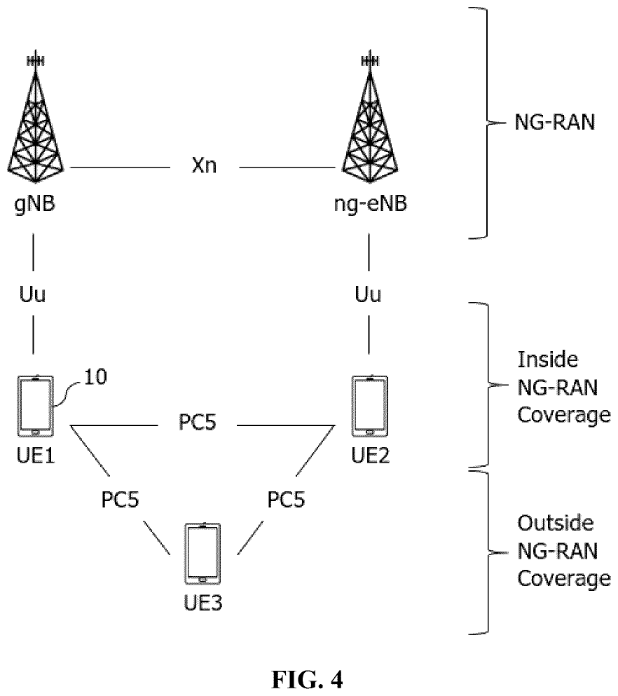

FIG. 4 illustrates an example of an NG-RAN architecture that supports a PC5 interface.

Referring to FIG. 4, the next generation-radio access network (NG-RAN) architecture supports the PC5 interface. Sidelink transmission and reception via the PC5 interface are supported both when the user equipment (UE) is inside NG-RAN coverage and when the UE is outside NG-RAN coverage, regardless of the radio resource control (RRC) state of the UE.

Vehicle-to-Everything (V2X) service support via the PC5 interface may be provided by NR sidelink communication and/or V2X sidelink communication. NR sidelink communication may also be used to support services other than V2X services.

NR sidelink communication may support one type among a unicast transmission mode, a groupcast transmission mode, and a broadcast transmission mode. In the case of unicast type sidelink communication, a UE may perform one-to-one communication with another UE. In the case of groupcast type sidelink communication, a UE may perform sidelink communication with one or more UEs within a group to which it belongs.

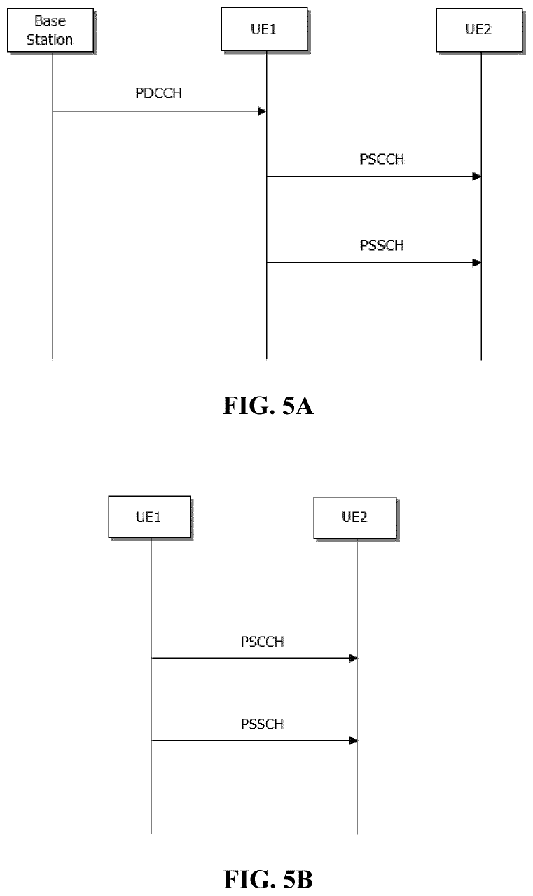

FIGS. 5A to 5B illustrate procedures for performing sidelink communication according to a sidelink resource allocation mode.

FIG. 5A illustrates a UE operation related to NR resource allocation mode 1, and FIG. 5B illustrates a UE operation related to NR resource allocation mode 2.

Referring to FIG. 5A, in NR resource allocation mode 1, a base station may schedule sidelink (SL) resources to be used by a user equipment (UE) for SL transmission. For example, the base station may perform resource scheduling for UE1 using a downlink control channel (DCI) transmitted via a physical downlink control channel (PDCCH), and UE1 may perform V2X or SL communication with UE2 according to the resource scheduling. For example, UE1 may transmit sidelink control information (SCI) to UE2 via the physical sidelink control channel (PSCCH), and then transmit SL data to UE2 via the physical sidelink shared channel (PSSCH) based on the SCI.

Referring to FIG. 5B, in NR resource allocation mode 2, a user equipment (UE) may determine a sidelink (SL) transmission resource within an SL resource configured by a base station or a pre-configured SL resource. For example, the configured SL resource or pre-configured SL resource may be a sidelink resource pool. For example, the UE may autonomously select or schedule a resource for SL transmission. That is, a UE may perform SL communication by autonomously selecting a resource within a configured resource pool. Furthermore, the UE may perform a sensing and resource (re) selection procedure to autonomously select a resource within a selection window. For example, the sensing may be performed on a sub-channel basis. As shown in FIG. 5B, UE1, which has autonomously selected a resource within the resource pool, may transmit SCI to UE2 via the PSCCH, and then transmit data based on the SCI to UE2 via the PSSCH.

In SL-U (Sidelink-Unlicensed), the technology for a UE-to-UE COT sharing scheme is under discussion and development, and it is a point in time where the development of data transmission/reception methods and operational methods related to COT sharing for SL communication in the unlicensed band is needed. Accordingly, this specification proposes methods related to the above description.

This specification will hereinafter specifically describe methods for the detailed operation related to COT sharing for SL communication in the unlicensed band.

First, regarding the description related to FIGS. 5A and 5B explained above, the sidelink control information (SCI) applied to the disclosure of this specification will be described in more detail.

SCI may be divided into two stages. The 1st stage is transmitted via a PSCCH associated with a PSSCH, and the 2nd stage is transmitted via the corresponding PSSCH. The 1st stage SCI may include information such as ‘Priority’, ‘Frequency resource assignment’, ‘Time resource assignment’, ‘Resource reservation period’, ‘Demodulation reference signal (DMRS) pattern’, ‘2nd-stage SCI format’, ‘Modulation and coding scheme’, ‘Reserved’, ‘Beta_offset indicator’, and ‘Number of DMRS port’. The 2nd stage SCI may include information such as ‘HARQ process ID’, ‘New data indicator’, ‘Redundancy version’, ‘Source ID’, ‘Destination ID’, and ‘Channel State Information (CSI) request’.

### First Disclosure: Method for an Indication Scheme for COT Initiation

### First Method of the First Disclosure

In SL-U, a UE may perform COT initiation by using a Type1 SL channel access scheme. Alternatively, the UE may send only the data or signals it intends to transmit without COT initiation. Whether a COT is being initiated may ultimately be determined by the presence or absence of COT-SI (sharing information). At least a portion or all of the COT-SI may be transmitted via SCI.

For convenience of description in this specification, a COT initiating UE refers to a UE that has initiated the corresponding COT, and a responding UE refers to the target UE of the COT initiating UE, i.e., the UE to which the COT initiating UE intends to transmit data/signals. A TX-UE refers to a terminal that intends to transmit data via SL communication in an unlicensed band, and an RX-UE refers to a UE that intends to receive data via SL communication in an unlicensed band. That is, a TX-UE may be a COT initiating UE, or a UE that intends to transmit its own data/signals via channel access without COT initiation. An RX-UE may be a responding UE, or a UE that intends to receive data/signals from a TX-UE that is not a COT initiating UE.

An RX-UE obtains information by decoding SCI and, based on the corresponding information, should be able to determine whether the COT initiating UE has performed COT initiation via the corresponding SCI, or whether it is SCI for a specific TX-UE to transmit data/signals without COT initiation. Therefore, the 1st stage SCI may include indication information about whether to perform COT initiation via the corresponding SCI. The corresponding information may be 1-bit information, and indication may be performed through modulation by the TX-UE and demodulation by the RX-UE of specific Radio Network Temporary Identifier (RNTI)-based SCI to indicate whether COT initiation occurs. That is, if SCI decoding based on a specific RNTI for indicating whether COT initiation occurs is successful, it may indicate that COT initiation is being performed.

In the above method, if it is possible to determine whether COT initiation is occurring via the 1st stage SCI, the RX-UEs may determine whether the bit field information delivered via the 2nd stage SCI is information about COT configuration or configuration information for the data/signals that the TX-UE intends to transmit. Through this, at a minimum, it is possible to configure different types of information with the same format of the 2nd stage SCI.

### Second Method of the First Disclosure

Unlike the first method, the 1st stage SCI may include indication information about a COT duration. To indicate the COT duration information, indication may be based on an RRC configured table. Table 5 is an example of a COT configured table for COT duration indication when the COT duration information is indicated with 2 bits. Table 5 shows information configured by RRC, and if the indication bit through the 1st stage SCI indicates ‘00’, it indicates that the COT duration is 0. In this case, it may indicate that no COT initiation is performed. If the indication bit through the 1st stage SCI indicates ‘10’, it indicates that the COT duration is 8. That is, a COT with a COT duration of 8 slots is initiated. In the example of Table 5, the unit of COT duration may be configured in various forms such as symbol, mini-slot, or frame, instead of a slot.

TABLE 4

| | Indicated COT |
|---|---|
| Indication bits | duration (slots) |
| 00 | 0 |
| 01 | 4 |
| 10 | 8 |
| 11 | 16 |

### Third Method of the First Disclosure

It is possible to operate by defining a new SCI format dedicated to COT initiation. In this case, if the RX-UE detects a new SCI format through blind decoding, it recognizes that COT initiation is being performed via the corresponding 1st stage SCI, and based on this, it may attempt channel access within the COT based on the COT-SI information obtained after decoding the 2nd stage SCI/PSSCH. If the TX-UE does not perform COT initiation, it may use the existing defined 1 st stage SCI format.

### Fourth Method of the First Disclosure

For COT initiating indication, in addition to the time/frequency resource allocation information for the data/signal transmitted by the TX-UE, resource allocation information for the COT may be included in the 2nd stage SCI, thereby providing an indication of COT initiation through the corresponding SCI. In an embodiment, an additional indication for the entire COT time resource can be indicated in the form of a direct time duration value such as the number of slots or us, or a time offset value based on the slot where the current SCI is transmitted. For frequency resources, it is possible to configure the PSCCH+PSSCH and the COT to use the same frequency resource region. In this case, it is not necessary to include additional frequency resource allocation information for the COT. Alternatively, within an RP, the unit of frequency resources may be divided based on RB, RB set, LBT sub-band/BW, and the frequency resource region allocated to the COT may be indicated in a bitmap format.

### Second Disclosure: Method for Operation Regarding Resource Sensing and Selection of a RA Mode 2 Terminal for Resources Allocated for COT Sharing

A UE that is not the target UE of a COT initiating UE but has successfully decoded the COT-SI may attempt to access the PSFCH occasion in the corresponding COT duration at any time. Therefore, to prevent this, when an arbitrary TX-UE performing resource sensing in an RA mode 2 situation obtains COT-SI information, it may be operated not to perform resource selection for the entire time/frequency resource of the corresponding COT or for the PSFCH occasions. That is, it may be configured and operated to either exclude the entire COT resource from candidate resources for resource selection, or to exclude only the PSFCH occasion.

### Third Disclosure: Method for COT-SI Update and Sharing Scheme

Within a COT, after the COT initiating UE's initial data/signal transmission, if the COT initiating UE transmits a PSCCH/PSSCH, the SCI of the corresponding PSCCH may include updated COT-SI. It may include at least the remaining COT duration information at the time of transmitting the current PSCCH/PSSCH. Furthermore, in order to apply the changed PSFCH occasion configuration from the time of transmitting the current PSCCH/PSSCH, it may include updated PSFCH configuration information. In the above method, the updated COT-SI may be configured and operated to be transmitted only by the COT initiating UE within the COT. In the above method, the COT initiating UE may transmit the updated COT-SI every time it transmits a PSCCH/PSSCH within the COT.

In the above method, in addition to the COT initiating UE, when a responding UE transmits a PSCCH/PSSCH to the COT initiating UE within the COT, the SCI of the corresponding PSCCH may include updated COT-SI. It may include at least the remaining COT duration information at the time of transmitting the current PSCCH/PSSCH. The transmission of the responding UE's COT-SI information may be operated such that when other terminals performing resource sensing and selection in RA mode 2 receive information about the COT transmitted by the responding UE, they do not perform resource selection for the entire time/frequency resources of the corresponding COT or for the PSFCH occasions. That is, it may be configured and operated to either exclude the entire COT resource from candidate resources for resource selection, or to exclude only the PSFCH occasion.

### Fourth Disclosure: Method for Operation in a Case where One UE Performs Communication with a Plurality of COT Initiating UEs

### First Method of the Fourth Disclosure

When one responding UE communicates with a plurality of COT initiating UEs, it receives respective COT-SI information from each COT initiating UE. For convenience of description in this specification, a case where one responding UE performs communication with two COT initiating UEs will be described. A case may occur where the responding UE attempts to perform channel access for data/signal transmission to each COT initiating UE when the resource regions of the two COTs overlap in whole or in part.

In the above description, the case where COT resources overlap refers to a case where, in a state of COT overlap in the time domain, some frequency resources, i.e., some Resource Blocks (RBs), an RB set, or an entire or partial LBT (Listen-Before-Talk) sub-band/BW, overlap.

The responding UE's procedure may differ depending on the type of channel access attempted for each COT initiating UE, and it may not be possible to attempt channel access for SL communication within one of the two COTs. In this case, performing SL communication through one COT may be dropped. That is, it may attempt to perform channel access to perform SL communication with one COT initiating UE.

If a receiving terminal must select one of two COTs to perform an SL transmission, it may determine the priority of a specific SL transmission based on the PQI (PC5 QoS (Quality of Service) Identifier), L1 priority, and CAPC (Channel Access Priority Classes) as criteria for COT selection for SL communication, and attempt to access the COT corresponding to that SL transmission.

### Second Method of the Fourth Disclosure

When one responding UE communicates with a plurality of COT initiating UEs, it receives respective COT-SI information from each COT initiating UE. In this disclosure, for convenience of description, a case where one responding UE performs communication with two COT initiating UEs will be described. A case may occur where the responding UE attempts to perform channel access for data/signal transmission to each COT initiating UE when the resource regions of the two COTs overlap in whole or in part.

If two configured COTs that can perform multi-channel access based on a COT having a plurality of RB sets have overlapping entire or partial multi-channels, the responding UE may attempt to access both COTs to perform both SL communications as much as possible.

The priority of a specific SL transmission is determined based on PQI, L1 priority, and CAPC, and data is transmitted on a frequency channel that does not overlap with resources between COTs among the channels without LBT failure in the COT corresponding to the high-priority SL. If there is no available channel among the channels that do not overlap between COT resources, SL communication is performed using an available channel among the overlapping frequency channels.

The SL transmission with the second priority may also perform SL communication using one of the channels excluding the channel for the priority SL transmission among the LBT successful channels.

That is, in the above method, the SL transmission grants precedence for channel selection for the SL transmission based on a specific priority value for each SL transmission. For the selection of a channel for SL communication within the COT resource corresponding to the SL transmission with precedence, precedence is granted to a channel that does not overlap with other COT resources. This is to minimize the use of overlapping resources to enable all possible SL communications to be performed. Once the channel to be used by the SL with precedence is selected, a channel for the SL with the next priority is selected from the remaining available channels. At this time, among the available channels within the COT resource corresponding to the SL with the next priority, precedence is granted to a channel that does not overlap with other COT resources, and that channel is selected. That is, when one responding UE communicates with two or more COT initiating UEs, it may be operated by applying the above method.

Furthermore, in the above method, even when the responding UE attempts to simultaneously perform a plurality of SL communications with each COT initiating UE via each COT, the above method may be applied in a simple, modified, combined, and/or extended form based on the transmission priority of all SLs to be transmitted for each COT.

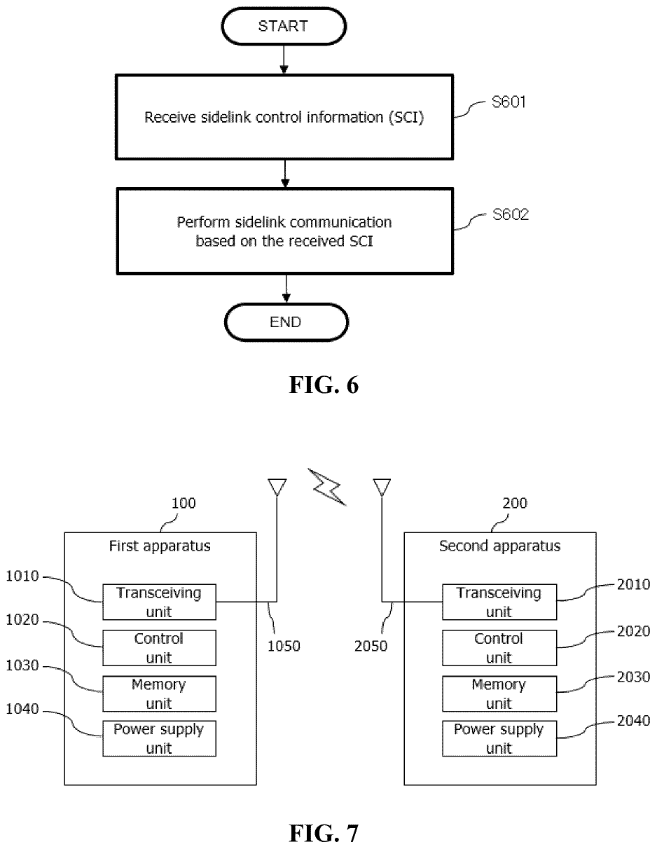

FIG. 6 illustrates a method for operating a terminal according to an embodiment of this specification.

Referring to FIG. 6, a terminal receives sidelink control information (SCI) (S601). Thereafter, the terminal performs sidelink communication based on the received SCI (S602). Here, the SCI may include information indicating whether to perform channel occupancy time (COT) initiation.

The information indicating whether to perform the COT initiation may be 1-bit information.

The SCI may further include COT duration information.

The SCI may be a 1st stage SCI dedicated to COT, and a 2nd stage SCI may be received after receiving the 1st stage SCI.

For resetting the period of the at least one first PSFCH occasion, COT-SI (sharing information) may be used.

The SCI may be a 2nd stage SCI, and the information indicating whether to perform the COT initiation may be resource allocation information for the COT.

The SCI may be a 1st stage SCI, updated COT-SI (sharing information) may be obtained through the 1st stage SCI, and the updated COT-SI may include remaining COT duration information.

Hereinafter, an apparatus to which the present specification may be applied will be described.

FIG. 7 illustrates a wireless communication apparatus according to an embodiment of the present specification.

Referring to FIG. 7, a wireless communication system may include a first apparatus (100) and a second apparatus (200).

The first apparatus (100) may be a base station, a network node, a transmitting terminal, a receiving terminal, a wireless device, a wireless communication device, a vehicle (e.g., a vehicle equipped with autonomous driving functions, a Connected Car), an Unmanned Aerial Vehicle (UAV), an Artificial Intelligence (AI) module, a robot, an Augmented Reality (AR) device, a Virtual Reality (VR) device, a Mixed Reality (MR) device, a hologram device, a public safety device, an MTC device, an IoT device, a medical device, a fintech device (or financial device), a security device, a climate/environmental device, a device related to 5G services, or a device related to other fields of the Fourth Industrial Revolution.

The second apparatus (200) may be a base station, a network node, a transmitting terminal, a receiving terminal, a wireless device, a wireless communication device, a vehicle (e.g., a vehicle equipped with autonomous driving functions, a Connected Car), an Unmanned Aerial Vehicle (UAV), an Artificial Intelligence (AI) module, a robot, an Augmented Reality (AR) device, a Virtual Reality (VR) device, a Mixed Reality (MR) device, a hologram device, a public safety device, an MTC device, an IoT device, a medical device, a fintech device (or financial device), a security device, a climate/environmental device, a device related to 5G services, or a device related to other fields of the Fourth Industrial Revolution.

The first apparatus (100) may include at least one processor such as a control unit (1020), at least one memory such as a memory unit (1030), and at least one transceiver such as a transceiver unit (1010). It may further include a power supply unit (1040) for supplying and controlling power to the control unit (1020), the memory unit (1030), and/or the transceiver unit (1010). The control unit (1020) may perform the functions, procedures, and/or methods described above. The control unit (1020) may execute one or more protocols. For example, the control unit (1020) may execute one or more layers of a wireless interface protocol. The memory unit (1030) is connected to the control unit (1020) and may store various types of information and/or instructions. The transceiver unit (1010) is connected to the control unit (1020) and may be controlled to transmit and receive wireless signals.

The second apparatus (200) may include at least one processor such as a control unit (2020), at least one memory such as a memory unit (2030), and at least one transceiver such as a transceiver unit (2010). It may further include a power supply unit (2040) for supplying and controlling power to the control unit (2020), the memory unit (2030), and/or the transceiver unit (2010). The control unit (2020) may perform the functions, procedures, and/or methods described above. The control unit (2020) may execute one or more protocols. For example, the control unit (2020) may execute one or more layers of a wireless interface protocol. The memory unit (2030) is connected to the control unit (2020) and may store various types of information and/or instructions. The transceiver unit (2010) is connected to the control unit (2020) and may be controlled to transmit and receive wireless signals.

The memory unit (1030) and/or the memory unit (2030) may be connected internally or externally to the control unit (1020) and/or the control unit (2020), respectively, and may also be connected to other control units through various technologies such as wired or wireless connections.

The first apparatus (100) and/or the second apparatus (200) may have one or more antennas. For example, the antenna (1050) and/or the antenna (2050) may be configured to transmit and receive wireless signals.

While preferred embodiments have been exemplarily described above, the disclosure of this specification is not limited to these specific embodiments, and thus may be modified, changed, or improved in various forms within the spirit of this specification and the scope described in the claims.

What is claimed is:

1. A method of a terminal for performing sidelink communication, the method comprising:
receiving a first physical sidelink control channel (PSCCH); and
receiving a first physical sidelink shared channel (PSSCH) after the receiving the first PSCCH,
wherein first sidelink control information (SCI) received via the first PSCCH includes first channel occupancy time (COT) sharing information.

2. The method of claim 1, wherein the first SCI is a first stage SCI, and the first COT sharing information is 1-bit information.

3. The method of claim 2, wherein remaining COT duration information is obtained through the first COT sharing information.

4. The method of claim 2, further comprising:
receiving a second stage SCI via the first PSSCH after receiving the first stage SCI.

5. The method of claim 4, wherein the second stage SCI includes second COT sharing information.

6. The method of claim 1, further comprising:
transmitting a second PSCCH and a second PSSCH to another terminal,
wherein second SCI transmitted via the second PSCCH includes third COT sharing information.

7. A terminal for performing sidelink communication, comprising:
a control unit; and
a memory unit to store instructions and operably and electrically connected with the control unit, wherein the instructions, when executed by the control unit, are configured to perform operations comprising:
receiving a first physical sidelink control channel (PSCCH), and
receiving a first physical sidelink shared channel (PSSCH) after the receiving the first PSCCH,
wherein first sidelink control information (SCI) received via the first PSCCH includes first channel occupancy time (COT) sharing information.

8. The terminal of claim 7, wherein the first SCI is a first stage SCI, and the first COT sharing information is 1-bit information.

9. The terminal of claim 8, wherein remaining COT duration information is obtained through the first COT sharing information.

10. The terminal of claim 8, wherein the operations further comprise:
receiving a second stage SCI via the first PSSCH after receiving the first stage SCI.

11. The terminal of claim 10, wherein the second stage SCI includes second COT sharing information.

12. The terminal of claim 7, wherein the operations further comprise:
transmitting a second PSCCH and a second PSSCH to another terminal,
wherein second SCI transmitted via the second PSCCH includes third COT sharing information.
